(19) United States
(12) Patent Application Publication
(10) Pub. No.: US 2026/0213234 A1
(43) Pub. Date: Jul. 23, 2026

(54) METHOD FOR A PROPERTY-RELATED ARRANGEMENT OF FUEL CELLS WITHIN A FUEL CELL STACK

(71) Applicant: Robert Bosch GmbH, Stuttgart (DE)

(72) Inventors: Jonas Breitinger, Stuttgart (DE); Erhard Hirth, Ellhofen (DE); Juergen Marquart, Memmelsdorf (DE)

(21) Appl. No.: 19/140,522

(22) PCT Filed: Dec. 20, 2023
(86) PCT No.: PCT/EP2023/086877

§ 371 Date: Jun. 18, 2025

(30) Foreign Application Priority Data
Dec. 21, 2022 (DE) 10 2022 214 236.5

(51) Int. Cl. H01M 8/04664; H01M 8/04223; H01M 8/2484

(52) U.S. Cl. CPC H01M 8/04679; H01M 8/04253; H01M 8/2484

(57) ABSTRACT

The invention relates to a method for a property-related arrangement of fuel cells (12) within a fuel cell stack (10) having the following steps:
a) characterizing individual or multiple fuel cells (12) with respect to the susceptibility thereof to have different faults (30, 40, 50, 60, 70) prior to arranging such fuel cells in the fuel cell stack (10);
b) arranging the fuel cells (12) characterized according to step a) within the fuel cell stack (10) in installation locations (80, 82, 84, 86) such that the effect of the faults (30, 40, 50, 60, 70) of fuel cells (12) ascertained according to step a) is minimized during operation of the fuel cell stack (10).

### BACKGROUND

The invention relates to a method for a property-related arrangement of fuel cells within a fuel cell stack. A characterization of individual or multiple fuel cells with respect to specific cell characteristics resulting in a susceptibility to have different faults takes place prior to arranging the fuel cells in the fuel cell stack.

Hydrogen-based PEM fuel cells only emit water as exhaust and allow for fast fueling times. For example, because individual fuel cells only provide a low voltage of 0.65 volts to 0.85 volts, several hundred fuel cells are electrically connected in series in automotive applications to thus produce a voltage level advantageous for power electronics. The individual fuel cells within the fuel cell stack are typically all the same components for cost reasons. Due to manufacturing tolerances, the individual cells differ in terms of different parameters, such as for example in terms of the geometry of the flow field, the distribution of the catalyst as well as the quality of the hydrophobic or hydrophilic coating. Furthermore, there are locations within the fuel cell stack where the flow through the fuel cells is better or worse, or where a slightly higher or lower temperature prevails compared to other locations within the fuel cell stack.

Currently, the individual fuel cells are positioned within the fuel cell stack independently of their production variations. However, this means that fuel cells that are particularly susceptible to certain faults due to their production variations, such as flooding, can be positioned at locations within the fuel cell stack where the media supply is particularly unfavorable compared to other locations within the fuel cell stack for this specific fault. This results in reduced system efficiency and a shortened service life of individual fuel cells and thus, potentially, the entire fuel cell stack.

In contrast, if all fuel cells are to be operated safely regardless of their location within the fuel cell stack, it must be ensured that the production variations are reduced. However, this comes with significantly increased costs for quality assurance, tools and test methods during manufacturing. On the other hand, in this case, operational management would have to be adapted so that all fuel cells are guaranteed to be supplied sufficiently with large production variations, which is accompanied by a significant increase in the gas flow in all fuel cells in order to safely prevent flooding of the most prone cell. However, this means that optimum system-level operation will not be achieved and significantly increased consumption of the accessory aggregates will cease.

### SUMMARY

According to the invention, a method for a property-related arrangement of fuel cells within a fuel cell stack is proposed with the following steps:
characterizing individual or multiple fuel cells with respect to the susceptibility thereof to have different faults prior to arranging such fuel cells in the fuel cell stack;
arranging the fuel cells characterized according to step a) within the fuel cell stack in installation locations such that the effect of the faults of fuel cells ascertained according to step a) is minimized during operation of the fuel cell stack.

By means of the method proposed according to the invention, a classification of individual fuel cells can be made prior to assembly in the fuel cell stack so that fuel cells with certain susceptibility to faults are used and in particular at the locations within the fuel cell stack where they have advantageous operating conditions despite their susceptibility to faults. This allows for an advantageous construction of the fuel cell stack from identical fuel cells that supports system efficiency. In this context, a certain loss of the efficiency of a fuel cell is also to be understood as a susceptibility to faults, even though the geometry of the fuel cell is still within the predetermined tolerances. Thus, a fault does not necessarily have to lead to fault of the fuel cell, but can only result in a reduction in the power of the fuel cell. The method according to the invention thus increases the performance of the fuel cell stack by advantageously positioning the individual fuel cells or their components within the stack.

Advantageously, the method proposed according to the invention can determine a susceptibility of individual or multiple fuel cells to one or more faults, and on the basis of such detection the respective fuel cells are positioned in installation locations within the fuel cell stack in an advantageous manner. The susceptibility to faults may result from specific cell characteristics such as geometrical measures, for example the channel depth of a flow field of the fuel cell.

In the method proposed according to the invention, during operation of the fuel cell stack, there is a higher temperature in the area between the end plates than below the upper end plate and above the lower end plate. Due to the thus known temperature level, certain temperature values of preferable, fault-prone fuel cells can be optimally positioned within the fuel cell stack, accordingly.

In the method proposed according to the invention, fuel cells near the lower end plate are preferably employed with an increased inlet pressure and an increased gas flow. That is to say, the media supply to the fuel cell stack occurs at the lower end plate.

By the method proposed according to the invention, characteristics properties can be considered for individual or multiple fuel cells, in particular due to individual production variations. The positioning of the fuel cells or their components within the stack is carried out on the basis of the specific cell characteristics. Based on the cell characteristics, susceptibility to faults, or increased risk of reduction in power due to the installation location, can be inferred.

This includes, for example, a high susceptibility to the “flooding” fault, which results in a second installation location of the fuel cell or fuel cells in question near the lower end plate within the fuel cell stack. That is to say, fuel cells whose specific cell characteristics indicate increased susceptibility to flooding-or have increased risk of power reduction due to flooding-are positioned near media inflow and outflow at the lower end plate where the increased flow rates counteract a flooding of the fuel cell.

Furthermore, according to the proposed method according to the invention, a fuel cell whose characteristic property, due to individual production variations, is that it has a higher susceptibility to the “high mass transport losses” fault, depending on the pressure and gas flow distribution for achieving a high outlet pressure, is arranged in a first installation location particularly near the upper end plate within the fuel cell stack.

Furthermore, the proposed method according to the invention enables a fuel cell whose characteristic property, due to individual production variations, is that it has a higher susceptibility to the “high mass transport losses” fault, depending on the pressure and gas flow distribution for achieving a high outlet pressure, is arranged within a second installation location near the upper end plate within the fuel cell stack.

Furthermore, the proposed method according to the invention enables a fuel cell whose characteristic property, due to individual production variations, is that it has a higher susceptibility to the “high Ohm losses” fault, is arranged in a first installation location near the upper end plate within the fuel cell stack.

Finally, with the proposed method according to the invention, a fuel cell whose characteristic property, due to individual production variations, is that it has a higher susceptibility to a “high activation losses” and/or a “risk of freezing” is placed in a second installation location above the lower end plate of the fuel cell stack.

With the method proposed according to the invention, this results in fuel cells without abnormalities being able to be placed within the fuel cell stack in any location. The method proposed according to the invention may be applied again for a new arrangement of the fuel cells within the fuel cell stack after a certain period of operation of the fuel cell stack has ended. As a result, both a full repetition of the method may be implemented or the method may be applied to the fuel cell stack in a decreased scope, or rearrangement of aged fuel cells may be performed within the fuel cell stack.

In particular, with the method proposed according to the invention, after a certain period of operation of the fuel cell stack, individual, excessively aged fuel cells can be replaced with new fuel cells.

With the method proposed according to the invention, the individual fuel cells can be characterized with respect to the susceptibility thereof to have different faults prior to arranging the fuel cells within the fuel cell stack. In the second step, the arrangement of the individual fuel cells previously characterized within the fuel cell stack is carried out in such a way that their installation is advantageous with regard to their susceptibility to faults resulting from production variations. This can avoid cell-specific faults, which can lead to excessive aging of the fuel cell in question, and thus to a power loss. In this way, higher system efficiency as a whole as well as increased service life of the individual fuel cells or the fuel cell stack can be achieved. By means of the method proposed according to the invention, in particular the characterization of the properties of individual fuel cells occurring prior to the construction of the fuel cell stack, a higher production tolerance can be allowed, whereby a considerable cost reduction can be achieved in the production of the fuel cells, since increased costs for quality assurance, tools and test methods during production are not incurred.

With the solution proposed according to the invention, optimally efficient system operation can be achieved with greater approximation of the operating limits and thus an increase in system efficiency.

### BRIEF DESCRIPTION OF THE DRAWINGS

Embodiments of the invention are described in greater detail hereinafter with reference to the drawings and the subsequent description.

Shown are:

FIG. 1.1 to 5.4, individual faults, tests to identify faults, probable causes and options for avoiding faults,

FIG. 6 a schematic structure of a fuel cell stack,

FIGS. 7, 8, 9 different parameters, such as temperature, pressure and gas flow, depending on the installation location of the individual fuel cells within the fuel cell stack according to FIG. 6.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

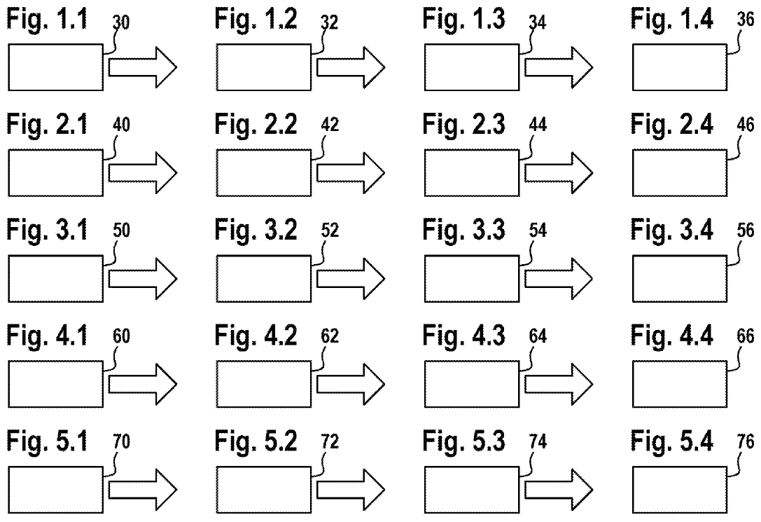

The illustrations of FIG. 1.1 to 5.4 show faults, tests to identify faults, probable causes of the faults, as well as options for avoiding the respective fault that occurred.

FIG. 1.1 to 1.4 relate to the “flooding” 30 fault. One test option for performing a test 32 for this “flooding” 30 fault is, for example, the reduction of the gas velocity at different flow strengths, whereby a cause 34 for the “flooding” fault 30 can be a faulty coating, a geometry of the flow field, or gas diffusion layers. Avoidance 36 of this “flooding” fault 30 may be achieved by positioning the fuel cell 12 in question in a location where a high gas flow is predominant.

The figure sequence in FIG. 2.1 to 2.4 relates to the “high mass transport losses” 40 fault. For example, a test 42 for the “high mass transport losses” fault 40 is to evaluate a VI characteristic curve using electrical impedance spectroscopy (EIS). The causes 44 for the “high mass transport losses” 40 fault are, for example, the geometry of the flow field and the gas diffusion layers as well as distribution of the catalyst. Avoidance 46 of the “high mass transport losses” 40 fault may be achieved by positioning the fuel cells 12 in such locations where there is a high gas flow and increased outlet pressure in the fuel cell stack 10.

FIG. 3.1 to 3.4 relate to the “Ohm losses” fault 50. A test 52 for detecting the “Ohm losses” 50 fault is in the evaluation of the VI characteristic curve of the high frequency resistance (HFR). A cause 54 for the “Ohm losses” 50 fault is the configuration of the membrane (CL=catalyst layer), the configuration of the interface, or the water transport properties of the gas diffusion layers. Avoidance 56 of the occurrence of the “Ohm' losses” 50 fault may be achieved by positioning the fuel cell 12 in question within the fuel cell stack 10 where there is a relatively low gas flow as well as lower temperatures within the fuel cell stack 10.

FIG. 4.1 to 4.4 relate to the “high activation losses” 60 fault. A test 62 for the “high activation losses” 60 fault is the evaluation of the UI characteristic curve by means of electrical impedance spectroscopy (EIS). The cause 64 of the occurrence of “high activation losses” 60 may be a decreased effective catalyst surface. An avoidance 66 of the occurrence of the “high activation losses” 60 fault may be achieved by positioning the fuel cell 12 in question, where there is a relatively high gas flow as well as higher temperatures within the fuel cell stack (10).

FIG. 5.1 to 5.4 relate to the “risk of freezing” 70 fault. A test 72 for the “risk of freezing” 70 fault relates to wet and dry cycles as well as to the measurement of the present water content. Causes 74 for the occurrence of the “risk of freezing” 70 fault are the water transport properties of the membrane and the gas diffusion layers, as well as the geometry of the flow field of the fuel cell 12 and the gas diffusion layers. Avoidance 76, or drastic reduction of the effects of this fault, may be achieved by positioning the fuel cell 12 in question within the fuel cell stack 10, where a relatively high gas flow and a relatively high temperature prevail within the fuel cell stack 10.

Looking together at FIG. 1.1 to 5.4, five different faults 30, 40, 50, 60, 70 arise, which are evidenced with tests 32, 42, 52, 62, 72, the possible causes of which are 34, 44, 54, 64, 74, and the option to avoid 36, 46, 56, 66, 76 or reduce the effects of faults 30, 40, 50, 60, 70 is by positioning the fuel cells 12 in question in suitable locations within the fuel cell stack 10.

Since the method proposed according to the invention requires a unique test of the individual fuel cells 12 or their cell components, cost-effective, easy-to-implement test methods are preferred. Some contemplated methods for determining relevant parameters for susceptibility to faults during operation of the fuel cells 12 are briefly outlined below.

A measurement of the flow field geometry may be performed using photogrammetry, wherein the dimensional accuracy of the individual channels of the flow field and the internal cell distribution structure may be quickly and cost-effectively tested. To further reduce the effort/expense, a limited number of channels can be selected according to stochastic criteria and checked for dimensional accuracy in order to thus draw conclusions about the geometrical quality of the present flow field. Local constrictions or too low a channel depth worsens the throughput of the respective channel and increases the susceptibility of the respective fuel cell to the “flooding” 30, “high mass transport losses” 40 and “risk of freezing”70 faults, because the water is not optimally removed during the previously performed drying operation.

A measurement of the layer thicknesses when graphitizing, i.e. after applying graphite to the stainless steel flow fields, can be performed, in which the expected transfer resistance is determined. As a constant proportion, this contributes to the Ohm losses 50, which, during later operation, are additionally influenced by the membrane water loading. If the percentage of transfer resistance is known, the cell-specific percentage of membrane resistance can be determined in more detail. In addition, at high contact resistances, a higher heat production of the respective fuel cell 12 is to be expected. Positioning on the edge of the fuel cell stack 10 is thus advantageous in order to homogenize the temperature profile throughout the fuel cell stack 10.

For example, a determination of the ionomer distribution may be made using a CO displacement measurement that determines the distribution of the ionomer in the catalyst layer. An unfavorable distribution of the ionomer alters water transport characteristics and may interfere with the operation of the fuel cell stack 10 in a variety of ways. Depending on the present distribution, there may be either more frequent drying out or more frequent flooding of the fuel cell 12 in question as compared to the remaining fuel cells 12. Depending on how the distribution differs from the ideal state, different locations within the fuel cell stack 10 can thus be advantageous (see also the “flooding” 30 or “high Ohm losses” 50 faults).

For example, determination of the platinum load of an electrode can be made via an X-ray fluorescence measurement, which can be used to infer the expected performance of the fuel cell 12. If the platinum load is above average, there is advantageous cell behavior with rather high voltage levels and a low risk of high mass transport losses 40. Accordingly, such fuel cells 12 are rather insensitive to a reactant undersupply. On the other hand, if the platinum load is less than average, the voltage level of the fuel cell 12 deteriorates in the entire operating range. In particular, the mass transport losses 40 may increase significantly due to the reduced active catalyst surface. If such a fuel cell 12 is detected, it should be placed at a location within the fuel cell stack 10 where there is an above-average good reactant supply, in order to avoid a sharp drop in voltage in the fuel cell 12 in question during a subsequent full load operation.

Alternatively to the X-ray method, a layer thickness measurement of the electrode may also be made. If the electrode thickness is below average, then a below-average platinum load can also be inferred.

If the variation of the manufacturing parameters is manageable, for example within a batch, and if deviations occur primarily between the individual batches due to tool changes, temperature or raw material changes, a unique test of the individual fuel cells 12 may be omitted entirely. By random sampling within a batch, the batch can be assigned to a deviation from the manufacturing parameters with a certain statistical probability. Thus, individual fuel cells 12 from a batch in which a constriction of the channels is observed due to random sampling, for example, can be advantageously distributed among a plurality of fuel cell stacks 10 according to the invention. The cell locations within the fuel cell stack 10 where flooding is particularly critical are, in turn, loaded with cells from a batch with no abnormalities.

To characterize the properties of a particular fuel cell 12 with still unknown production variations, various tests are performed as described in FIGS. 1.2, 2.2, 3.2. 4.2, 5.2. For example, to assess the susceptibility of a fuel cell 12 to the “flooding” 30 fault, the flow rate on the anode or the cathode is progressively reduced. If the flooding 30 occurs abnormally early in this fuel cell 12, this is most likely due to a deviation of the coating quality or geometry of the flow field or the gas diffusion layers. In order to minimize the power reduction due to this fault or its effects during operation of the fuel cell stack 10, the respective fuel cell 12 should consequently be placed at a location within the fuel cell stack 10 where the gas flow is higher than other locations within the fuel cell stack 12. Thus, flooding of the fuel cell 12 is thus counteracted by the comparatively high gas flow; the risk of power reduction through flooding is minimized.

For the remaining “high mass transport losses” 40, “high Ohm losses” 50, “high activation losses” 60 and “risk of freezing” 70 faults, requirements are placed on the relative locations at which a tested fuel cell 12 is placed within the fuel cell stack 10 according to the same approach.

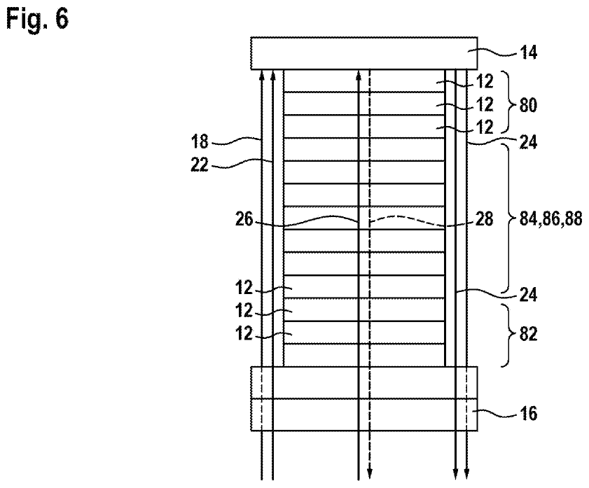

FIG. 6 shows a fuel cell stack 10 constructed of a number of fuel cells 12 arranged in a vertical direction above each other. The fuel cell stack 10 has an upper end plate 14 and a lower end plate 16. An inflowing cooling medium 18 enters the fuel cell stack 10 and exits it again as an outflowing cooling medium 20. Location 22 refers to inflowing hydrogen and location 24 refers to outflowing hydrogen. Inflowing air 26 exits the fuel cell stack 10 again as outflowing air 28. The different gas or mass flows are characterized by correspondingly directed arrows in the illustration according to FIG. 6.

In the fuel cell stack 10 shown in FIG. 6, the temperature in the center of the fuel cell stack 10, equidistant from the upper end plate 14 and the lower end plate 16, tends to be higher than in the area of the upper and lower end plates 14, 16. At the same time, fuel cells 12 located near the lower end plate 16 operate at a slightly increased inlet pressure and gas flow. A fuel cell 12, which, due to its individual production variations, has a susceptibility to the “flooding” fault 30, should therefore be placed near the lower end plate 16, consequently in a second installation location 82 in the fuel cell stack 10.

Fuel cells 12 that have a higher susceptibility to the “high mass transport losses” 40 fault require higher gas flows and/or higher outlet pressures to achieve a higher reactant partial pressure. Depending on the pressure and gas flow distribution, an installation location near the lower end plate 16, i.e. a second installation location 82, or an installation location near the upper end plate 14, i.e. a first installation location 80, can be selected for this purpose. In this particular case, the installation location therefore depends on the specific design.

Fuel cells 12 that have a high susceptibility to the occurrence of the “high Ohm losses” 50 fault should, on the other hand, be moistened more than average. For this purpose, the first installation location 80 is suitable in the area of the upper end plate 14, since relatively low temperatures as well as low gas flows prevail here. The risk of a power reduction of the fuel cells 12 due to Ohm losses is minimized for the fuel cells 12 within the first installation location 80.

Fuel cells 12 whose tests have indicated that they have a susceptibility to the “high activation losses” 60 fault or are susceptible to the “risk of freezing” 70 fault should be placed towards the lower end plate 16, i.e., at the lower portion of the fuel cell stack 10, but not directly at the lower end plate 16, as high temperatures and gas flows occur simultaneously here. For such fuel cells 12, a third or fourth installation location 84, 86 may be provided within the fuel cell stack 10.

Fuel cells 12 that show no particular susceptibility to the listed faults 30, 40, 50, 60, 70 may be distributed arbitrarily to the still vacant locations, i.e., they may be located centrally, for example in the area of third installation location 84, fourth installation location 86, or fifth installation location 88, in the fuel cell stack 10.

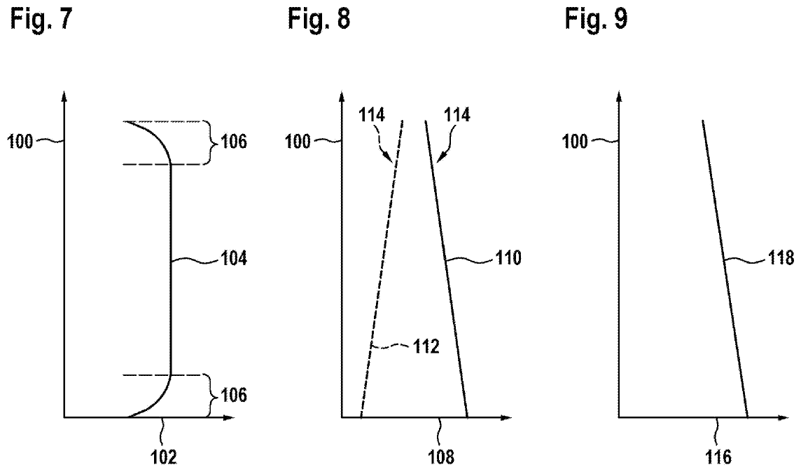

FIG. 7 is a temperature profile 104 of the temperature 102 plotted about the location 100 of the individual fuel cells 12 within the fuel cell stack 10. While a substantially uniform temperature prevails in the middle of the fuel cell stack 10, a rather low temperature range 106 exists in the area of the upper end plate 14 and the lower end plate 16.

FIG. 8 shows the pressure profile 108, also plotted about the location 100 of the fuel cells 12 in question within the fuel cell stack 10. From the graph according to FIG. 8, it is seen that an inlet pressure profile 110 has a negative gradient starting from the lower end plate 16 towards the upper end plate 14, which is due to the pressure losses. An outlet pressure profile 112 has a rather positive gradient but at a lower pressure level.

Finally, FIG. 9 shows a gas flow 116, also plotted about the location 100 of the fuel cells 12 within the fuel cell stack 10. A gradient 118 has a negative slope here.

As the individual fuel cells 12 arranged within the fuel cell stack 10 age unevenly, it makes sense to alter the arrangement of the fuel cells 12 within the fuel cell stack 10 over the period of operation. For this purpose, the method proposed according to the invention is repeated throughout the service life in its entirety or in a reduced scope, and, if necessary, a rearrangement of individual fuel cells 12 is carried out. Furthermore, there is also the possibility of replacing individual excessively aged fuel cells 12 with new fuel cells 12 in this step.

The invention is not limited to the exemplary embodiments described herein and the aspects highlighted thereby. Rather, within the range specified by the claims, a plurality of modifications is possible, which lie within the abilities of a person skilled in the art.

1. A method for a property-related arrangement of fuel cells (12) within a fuel cell stack (10) with the following steps:
a) characterizing individual or multiple fuel cells (12) with respect to a susceptibility thereof to have different faults (30, 40, 50, 60, 70) prior to arranging such fuel cells in the fuel cell stack (10);
b) arranging the fuel cells (12) characterized according to step a) within the fuel cell stack (10) in installation locations (80, 82, 84, 86) such that an effect of the faults (30, 40, 50, 60, 70) of fuel cells (12) ascertained according to step a) is minimized during operation of the fuel cell stack (10).

2. The method according to claim 1, wherein the susceptibility of individual or multiple fuel cells (12) to the occurrence of one or more faults (30, 40, 50, 60, 70) ascertained according to step a) results in their installation locations (80, 82, 84, 86) in the fuel cell stack (10).

3. The method according to claim 1, wherein, during operation of the fuel cell stack (10), higher temperatures are present in an area between end plates (14, 16), while lower temperatures (106) are present below an upper end plate (14) and above a lower end plate (16).

4. The method according to claim 3, wherein fuel cells (12) near the lower end plate (16) are operated at an increased inlet pressure (110) and an increased gas flow (116).

5. The method according to claim 3, wherein fuel cell (12), whose characteristic property, due to individual production variations, is that it has a higher susceptibility to a flooding (30) fault, is arranged within a second installation location (82) near the lower end plate (16) in the fuel cell stack (10).

6. The method according to claim 3, wherein a fuel cell (12) whose characteristic property, due to individual production variations, is that it has a higher susceptibility to a high mass transport losses (40) fault, depending on pressure and gas flow distribution for achieving a high outlet pressure, is arranged in a first installation location (80) near the upper end plate (14) in the fuel cell stack (10).

7. The method according to claim 3, wherein a fuel cell (12) whose characteristic property, due to individual production variations, is that it has a higher susceptibility to a high mass transport losses (40) fault, depending on pressure and gas flow distribution, for achieving a high outlet pressure, is arranged in a second installation location (82) near the lower end plate (16) in the fuel cell stack (10).

8. The method according to claim 3, wherein a fuel cell (12) whose characteristic property, due to individual production variations, is that it has a higher susceptibility to a high Ohm losses (50) fault, is arranged in a first installation location (80) near the upper end plate (14) in the fuel cell stack (10).

9. The method according to claim 3, wherein fuel cells (12), whose characteristic property, due to individual production variations, is that they have a higher susceptibility to a high activation losses (60) and/or a risk of freezing (70) fault, are placed in a second installation location (82) above the lower end plate (16) in the fuel cell stack (10).

10. The method according to claim 1, wherein fuel cells (12) without any abnormalities are placed in any location within the fuel cell stack (10).

11. The method according to claim 1, wherein a new sorting of the fuel cells (12) is carried out after a period of operating the fuel cell stack (10) has ended.

12. The method according to claim 11, wherein the method is repeated in its entirety or with a decreased scope or is carried out in a context of rearranging the fuel cells (12) within the fuel cell stack (10).

13. The method according to claim 11, wherein individual, excessively aged fuel cells (12) are replaced with new fuel cells (12) within the fuel cell stack (10).
